(19) United States
(12) Patent Application Publication
(10) Pub. No.: US 2024/0192957 A1
(43) Pub. Date: Jun. 13, 2024

(54) BRANCH TARGET BUFFER ACCESS SYSTEMS AND METHODS

(71) Applicant: Microsoft Technology Licensing, LLC, Redmond, WA (US)

(72) Inventors: Somasundaram ARUNACHALAM, Raleigh, NC (US); Daren Eugene STREETT, Cary, NC (US); Richard William DOING, Raleigh, NC (US)

(21) Appl. No.: 18/064,157

(22) Filed: Dec. 9, 2022

(51) Int. Cl. G06F 9/38

(52) U.S. Cl. CPC G06F 9/3806; G06F 9/3808

(57) ABSTRACT

Embodiments of the present disclosure include techniques for branch prediction. A branch predictor may be included in a processor. The branch predictor may use heuristics to control lookups against multiple different memory caches in a branch target buffer. In one embodiment, a branch predictor monitors successful lookups and a lookup is performed against one cache before another cache based on a number of successful lookups. In another embodiment, lookups are performed against different caches based on a current available capacity of a fetch target queue.

### BACKGROUND

The present disclosure relates generally to computing, and in particular, to branch prediction buffer access systems and methods.

Modern high-performance processors often deploy a decoupled front-end architecture to improve processor performance. In some processors front-ends, a branch predictor (BP) runs ahead of an instruction fetcher and enqueues instruction fetch addresses into a fetch target queue (FTQ). The branch predictor accesses branch target buffers (BTB) in order to generate fetch address bundles that get captured in FTQ. There may be multiple BTB memory levels present in BP. They may be accessed in parallel to limit the latency of providing fetch address bundles to FTQ and ensuring FTQ has addresses to fetch.

While accessing BTBs in parallel helps performance, it potentially consumes a lot of power unnecessarily, since a hit in lower level BTBs means that the upper level BTB access go unused, wasting power. Delaying the lookup for all upper-level BTB searches will reduce power consumption but negatively affect performance for workloads that do not fit in the lower level BTBs.

### BRIEF DESCRIPTION OF THE DRAWINGS

FIG. 1 illustrates a processor according to an embodiment.

FIG. 2 illustrates a branch prediction method according to an embodiment.

FIG. 3 illustrates an example of branch prediction according to another embodiment.

FIG. 4 illustrates another example of branch prediction according to an embodiment.

### DETAILED DESCRIPTION

Described herein are techniques for accessing a branch prediction buffer. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Features and advantages of the present disclosure include heuristic techniques for accessing different cache memory levels in a branch target buffer. According to various embodiments, the techniques presented herein speculatively accelerate or delay an address lookup (e.g., a search) of a BTB based on, for example, the probability of a hit at lower levels of the BTB or that an accelerated lookup does not speed up performance. Various signals may be used to detect code locality or FTQ fill level (capacity or occupancy), or both. For instance, if the past N number of accesses are successfully looked up in a lowest level memory cache (e.g., an L0 BTB Hit) and their replacement bit indicates that they are not recently used, for example, the system may perform lookups in the lowest memory cache rather than other memory caches (e.g., it is very likely that memory lookups will keep hitting in the lower cache levels). In other implementations, even if the heuristics indicates that there will likely be a BTB cache miss, if the FTQ is almost full, the benefits of speeding up BTB access are mostly lost by the time the instructions are transferred to the backend. It's also possible that the entire code footprint can fit in a lower-level BTB cache, or there are huge portions of code with no branches. Thus, for some cases, accessing memory caches based on FTQ fill level (capacity) allows for intelligent acceleration of lookups. Further embodiments are illustrated below.

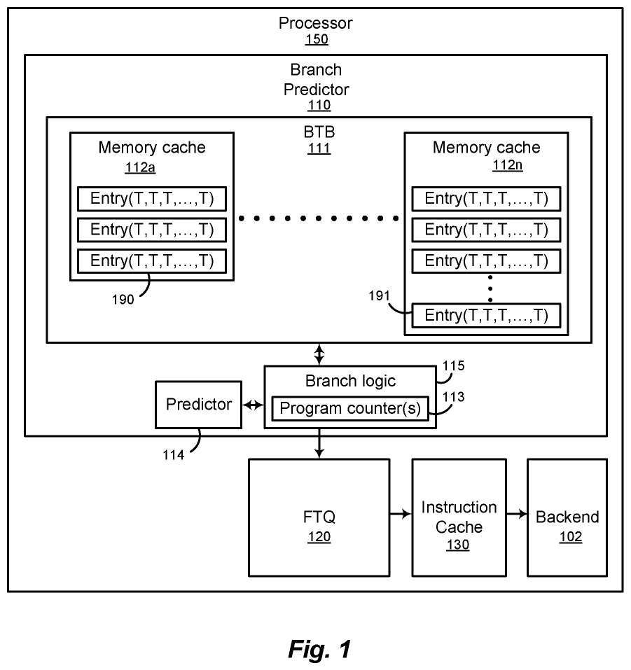

FIG. 1 illustrates a processor 150 according to an embodiment. Processor 150 include a branch predictor 110, a fetch target queue (FTQ) 120 coupled to a backend 102. In this example FTQ 120 is coupled to the backend through an instruction cache 130. Branch predictor 110 comprises one or more program counters 113 that generate a plurality of instruction addresses. The instruction address are addresses for instructions to be executed by the backend 102 of processor 150. Branch predictor 110 further includes a branch target buffer (BTB) 111 comprising a plurality of memory caches 112a-n. Memory caches 112a-n store branch target addresses (branch targets, T). Memory caches 112a-n store multiple branch targets in entries, such as entries 190 and 191, for example. Memory caches 112a-n may have different storage capacities (amounts of memory) and may have corresponding different performance (e.g., access latencies). Accordingly, memory caches 112a-n store different numbers of entries, which may be accessed faster or slower. Typically, a smaller memory cache can be accessed faster, while a larger memory cache is accessed more slowly. Thus, when speed is a factor, the techniques disclosed herein allow the processor to successfully lookup branch targets faster by monitoring successful lookup matches in memory caches 112a-n as described further below.

Branch predictor 110 further includes a predictor 114 and branch logic 115. In some embodiments, branch prediction logic combines information from BTB 411 and predictors to generate addresses (e.g., which are the starting points of a basic block of instructions). Each instruction in the block may have its own program counter value, for example, and branch prediction logic calculates the starting address and size of the block, from which each individual instruction program counter value can be derived. As addresses are generated, predictor 114 makes predictions as to whether branches at a particular address in the code are “taken” or “not taken” in parallel with a lookup being performed in BTB 111. Lookups are performed in BTB 111 to find branch target addresses that match an instruction address from program counter 113. Successful lookups return branch target addresses stored in one of the memory caches 112a-n, and if the address is “taken,” then the address is stored in FTQ 120. Accordingly, FTQ 120 stores a plurality of instruction addresses. In particular, FTQ 120 may stores the addresses of the start of the block of instructions, which can contain zero or more branch instructions, and in particular, the starting point and size of the block of instructions. With this information, FTQ 120 knows how many cache accesses to perform and how many instructions to send to fetch logic to be decoded and then ultimately sent to the backend for execution.

Advantageously, branch logic circuit 115 monitors successful lookup matches to memory caches 112a-n. Branch logic circuit 115 may perform different lookup strategies based on previous successful lookups. Accordingly, a lookup may be in one memory cache (e.g., memory cache 112a) before another memory cache (e.g., memory cache 112n) based on either, or both, of one memory cache having a higher number of successful lookup matches than another memory cache or a current available storage capacity of the fetch target queue, for example.

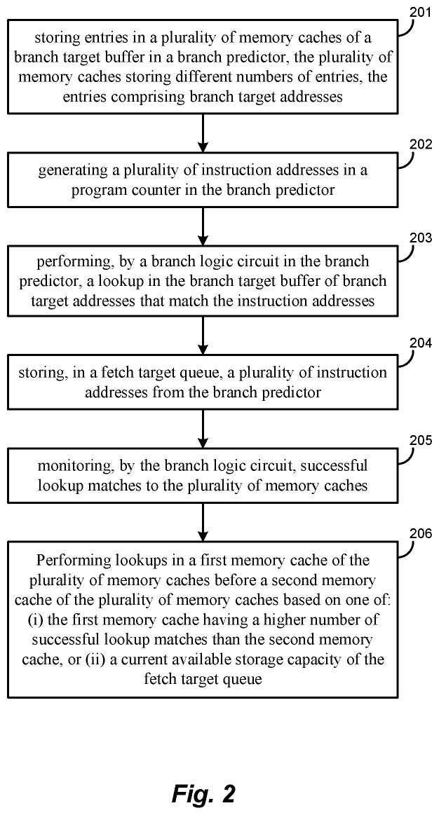

FIG. 2 illustrates a branch prediction method according to an embodiment. At 201, entries are stored in a plurality of memory caches of a branch target buffer in a branch predictor, the plurality of memory caches storing different numbers of entries, the entries comprising branch target addresses. At 202, a plurality of instruction addresses are generated in a program counter in the branch predictor. At 203, a lookup is performed in the branch target buffer of branch target addresses that match the instruction addresses (e.g., from a program counter). At 204, a plurality of instruction addresses from the branch predictor are stored in a fetch target queue. At 205, successful lookup matches to the plurality of memory caches are monitored by the branch logic circuit. At 206, lookups are performed in a first memory cache of the plurality of memory caches before a second memory cache of the plurality of memory caches based on one of: (i) the first memory cache having a higher number of successful lookup matches than the second memory cache, or (ii) a current available storage capacity of the fetch target queue.

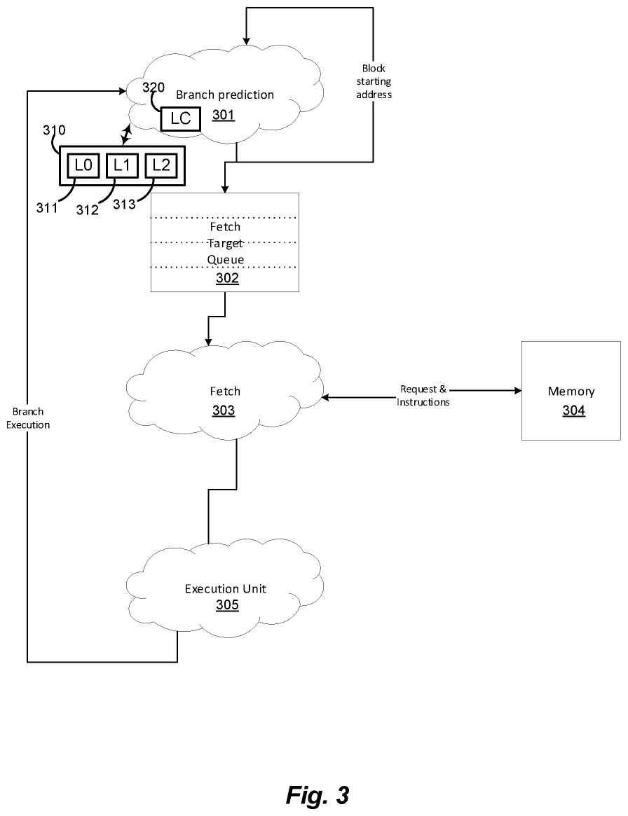

FIG. 3 illustrate an example of branch prediction according to another embodiment. The beginning stages of a microprocessor are often referred to as the “front end” of the machine, which typically include branch prediction 301 and instruction fetch logic 303. The later stages of a microprocessor are often referred to as the “back end” of the machine (execution unit 305), which typically include instruction execution and completion as well as logic to perform memory access (load and store) instructions. The branch prediction block 301 is a performance feature that speculates on the outcome of control flow instructions (e.g., conditional branch instructions with addresses stored in a branch target buffer (BTB) 310) prior to the execution of such instructions. The instruction fetch block 303 retrieves the instructions on that speculative path and presents them to the “back end” of the machine. The branch prediction 301 and instruction fetch 303 in the front end blocks are decoupled from one another such that they operate somewhat independently.

The branch prediction block 301 receives as its input an address corresponding to the start of a block of instructions. Based on information that it has cached in branch target buffer 310 related to that block of instructions, it generates a next address which feeds back to its own input. As those blocks flow through the branch prediction logic 301 they are enqueued into a fetch target queue 310 from which they are subsequently dequeued to the fetch block 303. In the fetch block 303, the actual instructions are retrieved from memory 304 (and cached in the instruction cache, not shown), decoded, and presented to the back end of the machine for execution. As branch instructions are executed in the execution unit 305, those that were not present in the branch target buffer 310 in the branch prediction block 301 are back annotated into the branch target buffer 310.

The following describes a view of a branch target buffer (BTB) 310 entry. BTB 310 is one component of branch prediction. It is responsible for maintaining information about branch instructions in memory (e.g., their location, type, and target). An example of a BTB entry is a tag/data pair in a cache memory array that consists of the following: [Tag] [Branch Info] [Branch Info] [Branch Info] . . . [Branch Info]

The tag component of the entry allows the entry to be compared against the address searching the BTB (the block starting address) during a lookup. The data component of the entry is comprised of information for branch instructions that are present in the entry. That information includes the type of branch instruction, its location relative to the beginning of the basic block (group of sequential instructions), and the target address of the branch instruction (aka, the branch target address).

One example of a BTB entry is one that corresponds to an entry in the instruction cache. The two would be tagged in the same way (e.g., by the virtual address of the beginning of the cache line) and each “slot” in the BTB entry could represent a branch at that location in the cache line. Where the instruction cache stores the opcode of the instruction at that location in the cache, the BTB stores whether a branch is present at that location, the type of branch, and the target of the branch.

In some example embodiments, the way that a BTB entry is populated (aka, trained) is slightly different from that of a traditional instruction or data cache. At the beginning of time (just after reset), the BTB will be void of any valid entries (same for the instruction/data cache). All addresses that search the BTB will have unsuccessful lookups, and the hardware will behave as if no branch instructions are present in the code—it will assume that the code flows sequentially through memory. Those addresses also miss in the instruction cache, at which point in time they must be fetched from a higher level cache (or memory). As instructions are fetched from memory and executed in the execution unit, among those instructions will be branch instructions. Once they are observed in the execution unit, they can be back-annotated into the BTB 310 at the appropriate location.

The following is an example sequence of assembly code instructions that are the first instructions fetched after reset (virtual address and instruction pairs)

```
    1. 0x00000000 MOVE
    2. 0x00000004 ADD
    3. 0x00000008 MOVE
    4. 0x0000000C ADD
    5. 0x00000010 BL target_1
    6. 0x00000014 MOVE
    7. 0x00000018 ADD
    8. 0x0000001C MOVE
    9. 0x00000020 ADD
  10. 0x00000024 BL target_2
  11. 0x00000028 MOVE
  12. 0x0000002C ADD
  13. 0x00000030 LOAD
  14. 0x00000034 LOAD
  15. 0x00000038 STORE
  16. 0x0000003C STORE
...
target_1:
0x00001000 LOAD
0x00001004 STORE
0x00001008 RET
...
target_2:
0x00002000 ADD
0x00002004 STORE
0x00002008 RET
...
```

For the above example code, assume a 32 byte cache line where addresses 0x00000000-0x0000001C are the first line of the instruction cache (lines 1-8) and 0x00000020-0x0000003C are the second line of the instruction cache (lines 9-16). The first line could be tagged with address 0x00000000 and the second line could be tagged with 0x00000020. The first three instructions of the cache lines beginning at 0x00001000 and 0x00002000 are also shown as they are the targets of the call branch instructions at 0x00000010 and 0x00000024, respectively.

In this example, the processor may reset to address 0x00000000, and the branch predictors would be searched with that address. The resulting search would result in a miss, and the branch predictor would assume that no branches exist in that code, so it would proceed to the address of the next sequential block of instructions, address 0x00000020 in this case. The initial address 0x00000000 is enqueued into the Fetch Target Queue (FTQ) 302 and eventually to the fetch block 303, where it would search the instruction cache (and also miss, making a request to memory for the instructions). Progress is stalled for that block until the instructions are returned from memory, at which point in time they may be presented to the execution unit 305 and also written into the instruction cache. The block starting at 0x00000020 would behave in the same manner, missing in branch prediction structures and the instruction cache the same way that the block at 0x00000000 did.

Eventually, the branch-and-link instruction (BL, also known as a subroutine call) at address 0x00000010 would execute and the execution unit would notify the instruction unit that program flow should not be sequential after that instruction but instead should proceed at the target of that branch instruction (known as a branch mispredict or branch correction). It is at that point in time that the BTB 310 could be annotated with information about that branch (e.g., its tag 0x00000000, it is a subroutine call type branch, and its target is 0x00001000).

Following the correction due to the BL at address 0x00000010 to 0x00001000, the BTB would be searched with 0x00001000 and the same behavior would be repeated (miss in the BTB, miss in the instruction cache, etc.) until the subroutine return (RET) branch instruction were executed and performed its own branch correction to 0x00000014, the target or the RET branch instruction. Now, the BTB 310 will have been populated with an entry whose tag is 0x00000000 containing the BL instruction at 0x00000014 whose target address is 0x00001000 and a second entry whose tag is 0x00001000 containing the RET branch instruction at address 0x00001008 whose target address is 0x00000018.

BTB 310 may comprise 3 levels of cache—L0 311, L1 312, and L2 313, which are different sizes and have corresponding different speeds, where L0 is the smallest and fastest, L1 is larger and slower than L0, and L2 is larger and slower than L1, for example. L0 may be referred to as a lower hierarchical level than L1, and L1 may be referred to as a lower hierarchical level than L2, for example. Features and advantages of the present disclosure reduce power in the processor without sacrificing performance by employing a heuristic that predicts whether the access to the last level BTB (L2) will likely be required (i.e., the access is likely to miss in the lower level BTBs L0 and L1). The predictions may be based on code locality in each cache, for example.

Based on code locality, hit rates in lower levels in the BTB hierarchy can be used to determine whether the highest level table will be required. High hit rates in the lower levels over a period of time indicate that the likelihood of high hit rates in the lower level tables will likely continue for a period of time. Similarly, low hit rates in the lower level tables indicate that the likelihood of low hit rates in the lower level tables will continue for a period of time. This information can be used to trade power consumption versus latency (performance) in the highest level table.

For example, the most performant implementation of the hierarchy would be to access (speculatively) the highest level of the BTB hierarchy (L2) before knowledge of the result of the search in the lower level BTBs is obtained. If the access to one of the lower level tables resulted in a hit, the access to the highest level would be discarded and the power spent performing the access was wasted. If the access to the lower level BTBs resulted in a miss in all of those BTBs, then the speculative access to the highest level BTB is able to provide its result with lower latency than if the access was delayed until the result from the lower levels was known.

Conversely, the most power efficient implementation of the hierarchy would be to delay the access of the highest level of the BTB hierarchy until knowledge of the result of the search in the lower level BTBs is obtained. Here, the highest level BTB would only be accessed if the access to the lower level BTBs resulted in a miss in all those BTBs.

Dynamically selecting between the performant and efficient access policy is possible using a heuristic that predicts whether or not the highest level BTB will be needed to provide the information. In one embodiment, branch predictor 301 includes a lookup counter (LC) 320 to count a number of successful lookup matches of one or more of the L0 cache 311 and the L1 cache 312. Lookup counter 320 may be saturating counter (e.g., a counter that counts to a maximum value and then stops) that maintains a count of consecutive successful lookups (“hits”) in accesses to the lower level tables L0 and/or L1 as one metric that participates in the heuristic. A counter that meets a threshold (e.g., high number of hits to the lower level caches L0 and/or L1) indicates that the access to the highest level BTB (L2) should be delayed until the result of the lower level BTBs is known. A counter that does not meet the threshold (e.g., hits less than the maximum counter value) indicates that the access to the highest level BTB should not be delayed such that its information is available as early as possible.

In one hardware example a 5-bit counter is used, and the range of values it can represent are 0 to 31. There can be two types of counters. Saturating counters and wrap around counters. As mentioned above, counters that saturate may be used to stay at the maximum value, once they reach it, to track that there have been a certain number of hits at the lower level of the cache.

In some embodiments, another heuristic is the relative fullness (or available storage capacity) of the FTQ 302. If a substantial number of blocks of instructions have been enqueued in the FTQ 302, then there may not be a performance penalty in delaying the highest level BTB L2 access, and the power savings can be accomplished without affecting throughput. In other words, if the FTQ 302 has queued up a sufficient number of prior BTB results such that it can “hide” the latency of the L2 access, then available storage capacity of the BTB may be used to determine memory cache access with additional latency and improved power efficiency.

Some embodiments may combine the two techniques. For example, if an L0 or L1 access hit counter is saturated, or if the FTQ is at a current available storage capacity that can hide the L2 latency, then the access to L2 may be delayed until the lower level results are known. No speculative accesses to the L2 should be made in this mode. However, if the counter is not saturated or if the FTQ cannot hide the latency of an L2 access, then L2 may be accessed speculatively to provide its result with minimal latency.

The following algorithm illustrates an example embodiment:

```
if (L0 BTB Hit or L1 BTB Hit)
  if(Lower Level Hit Counter != MAX VALUE )
    Lower Level Hit Counter = Lower Level Hit Counter + 1;
  else
    Do nothing
else
  Lower Level Hit Counter = 0;
```

In the above pseudo code, if the lower level caches L0 or L1 produce a successful lookup, then lower level hit counters are incremented unless they are already at a maximum value (e.g., they are saturated). If there is no hit on L0 or L1, then the counters are reset to zero.

The following algorithm illustrates another example embodiment:

```
if(Lower Level Hit Counter < PRE CONFIGURED THRESHOLD
VALUE)
  L2 BTB Search is not delayed
else
  L2 BTB Search is delayed
```

In the above algorithm, if a lower level counter is less than some configured threshold value, a lookup in the L2 is performed before lookups of the lower level caches L0 and/or L1 are completed. Otherwise, the lookup in L2 is performed after the results from L0 and/or L1 are available. Accordingly, lookups are performed in one or more of the L0 and the L1 cache and produce at least one result before performing the lookup in the L2 cache when the lookup counter is above the threshold (PRE CONFIGURED THRESHOLD VALUE). Conversely, lookups are performed in one or more of the L0 and the L1 cache and the L2 cache before the one or more of the L0 and the L1 cache produce at least one result when the lookup counter is below the threshold. Additionally, in some embodiments, the lookup may be performed in one or more of the L0 and the L1 cache and produces at least one result before performing the lookup in the L2 cache when the lookup counter is above the threshold and when the fetch target queue is below a threshold available capacity.

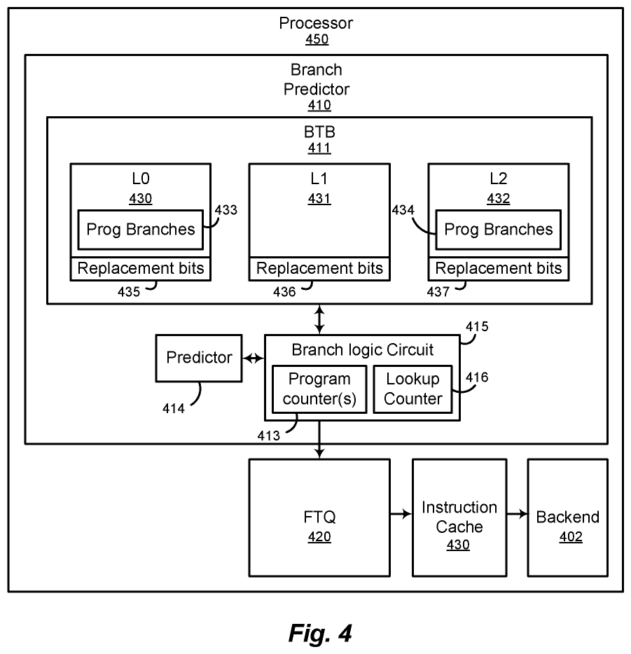

FIG. 4 illustrates another example processor 450 including a branch predictor 410 according to an embodiment. Branch predictor 410 includes a branch target buffer (BTB) 411, program counter 413, predictor 414, branch logic 415, and lookup counter 416. In this example, BTB 411 includes three memory caches L0 430, L1 431, and L2 432, where the L1 cache has a greater number of entries than the L0 cache, and the L2 cache has a greater number of entries than the L1 cache. Accordingly, L2 may store more branches for a program 434 than the number of program branches 433 stored in L0. Program branches for smaller code blocks may fit substantially or entirely in L0, while program branches for larger code blocks may be stored in L1, and program branches for even larger code blocks may be stored in L2, for example. In this example, each memory cache includes replacement bits 435-437. Replacement bits are associated with entries in each cache. Replacement bits may correspond to a recency of use for the entries stored in the caches (e.g., replacement bits may measure which entries were accessed most recently or least recently). Additionally, branch logic circuit 415 may move entries from a larger memory cache to a smaller memory cache in response to unsuccessful lookups in the smaller memory cache and successful lookups in the larger memory cache, for example. Accordingly, branch targets in the entries of the different caches may change over time. In one embodiment, the replacement bits rank, by recency of use, entries stored in the caches. Accordingly, in some embodiments, branch logic circuit 415 monitors replacement bits associated with entries returned for successful lookup matches. Lookups may be performed in one memory cache before another memory cache based on the replacement bits associated with the entries returned for successful lookup matches, for example.

As mentioned above, lookup counter 416 may count successful lookups to L0 and/or L1 and impact how lookups are performed against L2. Matching branch target addresses that are “taken” are forwarded to FTQ 420 and backend 402. In some embodiments, an instruction cache 430 may be used.

### Further Examples

Each of the following non-limiting features in the following examples may stand on its own or may be combined in various permutations or combinations with one or more of the other features in the examples below. In various embodiments, the present disclosure may be implemented as a processor or method.

In one embodiment, the present disclosure includes a processor comprising: a branch predictor comprising: a branch target buffer comprising a plurality of memory caches, the plurality of memory caches storing different numbers of entries, the entries comprising branch target addresses; and a branch logic circuit configured to generate a plurality of instruction addresses and to lookup, in the branch target buffer, branch target addresses that match the instruction addresses; and a fetch target queue storing a plurality of instruction addresses from the branch predictor, wherein the branch logic circuit monitors successful lookup matches to the plurality of memory caches, and wherein the branch logic circuit performs a lookup in a first memory cache of the plurality of memory caches before a second memory cache of the plurality of memory caches based on one of: the first memory cache having a higher number of successful lookup matches than the second memory cache, or a current available storage capacity of the fetch target queue.

In another embodiment, the present disclosure includes a method of predicting branches in a processor comprising: storing entries in a plurality of memory caches of a branch target buffer in a branch predictor, the plurality of memory caches storing different numbers of entries, the entries comprising branch target addresses; generating a plurality of instruction addresses in the branch predictor; performing, by a branch logic circuit in the branch predictor, a lookup in the branch target buffer of branch target addresses that match the instruction addresses; storing, in a fetch target queue, a plurality of instruction addresses from the branch predictor; and monitoring, by the branch logic circuit, successful lookup matches to the plurality of memory caches, wherein the branch logic circuit performs a lookup in a first memory cache of the plurality of memory caches before a second memory cache of the plurality of memory caches based on one of: the first memory cache having a higher number of successful lookup matches than the second memory cache, or a current available storage capacity of the fetch target queue.

In one embodiment, the branch logic circuit performs the lookup in the first memory cache of the plurality of memory caches before the second memory cache of the plurality of memory caches based on the first memory cache having the higher number of successful lookup matches than the second memory cache.

In one embodiment, the branch logic circuit performs the lookup in the first memory cache of the plurality of memory caches before the second memory cache of the plurality of memory caches based on the current available storage capacity of the fetch target queue.

In one embodiment, the branch logic circuit performs the lookup in the first memory cache of the plurality of memory caches before the second memory cache of the plurality of memory caches based on the first memory cache having the higher number of successful lookup matches than the second memory cache and the current available storage capacity of the fetch target queue.

In one embodiment, monitoring successful lookup matches to the plurality of memory caches comprises determining a number of successful lookup matches for each particular memory cache out of a running total number of successful lookup matches.

In one embodiment, the branch logic circuit monitors replacement bits associated with entries returned for successful lookup matches, and wherein the branch logic circuit performs the lookup in the first memory cache of the plurality of memory caches before the second memory cache of the plurality of memory caches based on the replacement bits associated with the entries returned for successful lookup matches.

In one embodiment, the replacement bits correspond to a recency of use for the entries stored in the plurality of caches.

In one embodiment, the replacement bits rank, by recency of use, entries stored in the plurality of caches.

In one embodiment, the plurality of memory caches comprises an L0 cache, an L1 cache having a greater number of entries than the L0 cache, and an L2 cache having a greater number of entries than the L1 cache.

In one embodiment, at least one lookup counter counts a number of successful lookup matches of one or more of the L0 cache and the L1 cache, wherein: the branch logic circuit performs the lookup in one or more of the L0 and the L1 cache and produces at least one result before performing the lookup in the L2 cache when the lookup counter is above a threshold; and the branch logic circuit performs the lookup in one or more of the L0 and the L1 cache and the L2 cache before the one or more of the L0 and the L1 cache produce at least one result when the lookup counter is below the threshold.

In one embodiment, the branch logic circuit performs the lookup in one or more of the L0 and the L1 cache and produces at least one result before performing the lookup in the L2 cache when the lookup counter meets a threshold and when the fetch target queue is below a threshold current available capacity.

In one embodiment, the lookup counter comprises a saturating counter that reaches a maximum value and stops counting.

In one embodiment, the threshold is configurable.

In one embodiment, the branch logic circuit moves entries from a larger memory cache to a smaller memory cache in response to a plurality of unsuccessful lookups in the smaller memory cache and successful lookups in the larger memory cache.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A processor comprising:
a branch predictor comprising:
a branch target buffer comprising a plurality of memory caches, the plurality of memory caches storing different numbers of entries, the entries comprising branch target addresses; and
a branch logic circuit configured to generate a plurality of instruction addresses and to lookup, in the branch target buffer, branch target addresses that match the instruction addresses; and
a fetch target queue storing a plurality of instruction addresses from the branch predictor,
wherein the branch logic circuit monitors successful lookup matches to the plurality of memory caches, and
wherein the branch logic circuit performs a lookup in a first memory cache of the plurality of memory caches before a second memory cache of the plurality of memory caches based on one of:
the first memory cache having a higher number of successful lookup matches than the second memory cache, or
a current available storage capacity of the fetch target queue.

2. The processor of claim 1, wherein the branch logic circuit performs the lookup in the first memory cache of the plurality of memory caches before the second memory cache of the plurality of memory caches based on the first memory cache having the higher number of successful lookup matches than the second memory cache.

3. The processor of claim 1, wherein the branch logic circuit performs the lookup in the first memory cache of the plurality of memory caches before the second memory cache of the plurality of memory caches based on the current available storage capacity of the fetch target queue.

4. The processor of claim 1, wherein the branch logic circuit performs the lookup in the first memory cache of the plurality of memory caches before the second memory cache of the plurality of memory caches based on the first memory cache having the higher number of successful lookup matches than the second memory cache and the current available storage capacity of the fetch target queue.

5. The processor of claim 1, wherein monitoring successful lookup matches to the plurality of memory caches comprises determining a number of successful lookup matches for each particular memory cache out of a running total number of successful lookup matches.

6. The processor of claim 1, wherein the branch logic circuit monitors replacement bits associated with entries returned for successful lookup matches, and wherein the branch logic circuit performs the lookup in the first memory cache of the plurality of memory caches before the second memory cache of the plurality of memory caches based on the replacement bits associated with the entries returned for successful lookup matches.

7. The processor of claim 6, wherein the replacement bits correspond to a recency of use for the entries stored in the plurality of caches.

8. The processor of claim 7, wherein the replacement bits rank, by recency of use, entries stored in the plurality of caches.

9. The processor of claim 1, wherein the plurality of memory caches comprises an L0 cache, an L1 cache having a greater number of entries than the L0 cache, and an L2 cache having a greater number of entries than the L1 cache.

10. The processor of claim 9, further comprising at least one lookup counter to count a number of successful lookup matches of one or more of the L0 cache and the L1 cache, wherein:
the branch logic circuit performs the lookup in one or more of the L0 and the L1 cache and produces at least one result before performing the lookup in the L2 cache when the lookup counter is above a threshold; and
the branch logic circuit performs the lookup in one or more of the L0 and the L1 cache and the L2 cache before the one or more of the L0 and the L1 cache produce at least one result when the lookup counter is below the threshold.

11. The processor of claim 10, wherein the branch logic circuit performs the lookup in one or more of the L0 and the L1 cache and produces at least one result before performing the lookup in the L2 cache when the lookup counter meets a threshold and when the fetch target queue is below a threshold current available capacity.

12. The processor of claim 10, wherein the lookup counter comprises a saturating counter that reaches a maximum value and stops counting.

13. The processor of claim 10, wherein the threshold is configurable.

14. The processor of claim 1, wherein the branch logic circuit moves entries from a larger memory cache to a smaller memory cache in response to a plurality of unsuccessful lookups in the smaller memory cache and successful lookups in the larger memory cache.

15. A method of predicting branches in a processor comprising:
storing entries in a plurality of memory caches of a branch target buffer in a branch predictor, the plurality of memory caches storing different numbers of entries, the entries comprising branch target addresses;
generating a plurality of instruction addresses in the branch predictor;
performing, by a branch logic circuit in the branch predictor, a lookup in the branch target buffer of branch target addresses that match the instruction addresses;
storing, in a fetch target queue, a plurality of instruction addresses from the branch predictor; and
monitoring, by the branch logic circuit, successful lookup matches to the plurality of memory caches,
wherein the branch logic circuit performs a lookup in a first memory cache of the plurality of memory caches before a second memory cache of the plurality of memory caches based on one of:
the first memory cache having a higher number of successful lookup matches than the second memory cache, or
a current available storage capacity of the fetch target queue.

16. The method of claim 15, wherein the branch logic circuit performs the lookup in the first memory cache of the plurality of memory caches before the second memory cache of the plurality of memory caches based on the first memory cache having the higher number of successful lookup matches than the second memory cache and the current available storage capacity of the fetch target queue.

17. The method of claim 15, wherein the branch logic circuit monitors replacement bits associated with entries returned for successful lookup matches, and wherein the branch logic circuit performs the lookup in the first memory cache of the plurality of memory caches before the second memory cache of the plurality of memory caches based on the replacement bits associated with the entries returned for successful lookup matches.

18. The method of claim 17, wherein the replacement bits correspond to a recency of use for the entries stored in the plurality of caches.

19. The method of claim 18, wherein the replacement bits rank, by recency of use, entries stored in the plurality of caches.

20. The method of claim 15, wherein the plurality of memory caches comprises an L0 cache, an L1 cache having a greater number of entries than the L0 cache, and an L2 cache having a greater number of entries than the L1 cache, and wherein at least one lookup counter counts a number of successful lookup matches of one or more of the L0 cache and the L1 cache, wherein:
the branch logic circuit performs the lookup in one or more of the L0 and the L1 cache and produces at least one result before performing the lookup in the L2 cache when the lookup counter is above a threshold; and
the branch logic circuit performs the lookup in one or more of the L0 and the L1 cache and the L2 cache before the one or more of the L0 and the L1 cache produce at least one result when the lookup counter is below the threshold.
